(19) United States
(12) Patent Application Publication
(10) Pub. No.: US 2009/0130948 A1
(43) Pub. Date: May 21, 2009

(54) Toy and method for delivering water

(76) Inventor: James Douglas Deasy, II, Mill Valley, CA (US)

Correspondence Address: Law Offices of John W. Carpenter;John W. Carpenter, 12 Metairie Court, Metairie, LA, 70001, US

(21) Appl. No.: 11/986,007

(22) Filed: Nov. 20, 2007

(51) Int. Cl. A63H 3/06; B05B 7/32

(52) U.S. Cl. 446/220; 239/337

(57) ABSTRACT

A recreational toy is provided. The toy may be expanded from a collapsed state into an expanded state which includes inflated sections having arcuate, or generally sinusoidal-shaped, surfaces. A perforated hollow chamber is coupled to the inflated sections. A method for discharging, sprinkling or delivering water from an inflated toy assembly is further provided. As water is being introduced into a perforated hollow chamber, water commences to sprinkle or be discharged through perforations in the hollow chamber.

### FIELD OF THE INVENTION

Embodiments of the present invention are related to a fluid (e.g., water) delivery system. More specifically, embodiments of the present invention provide a toy assembly and method for spraying water from an inflated body having arcuate surfaces.

### BACKGROUND OF THE INVENTION

There are a number of conventional toys which discharge water, such as: crazy legs caterpillar, wiggling water sprinkler, wiggling water snake sprinkler, and Spinning Spider Linky Sprinks Sprinkler (manufactured by In-tact Toy Co.) However, none combine inter alia the features a hollow chamber or strip supported by an inflated assembly (a toy assembly which has the appearance of a caterpillar) for delivering water through perforations in the hollow chamber.

### SUMMARY OF THE EMBODIMENTS OF THE INVENTION

Embodiments of the present invention provide an apparatus or hollow toy for spraying or delivering water. After air is introduced into the hollow toy, an inflated toy is formed comprising a generally open “S” shape and including at least one inflated portion or section having arcuate, or generally sinusoidal-shaped, surfaces. A perforated hollow chamber is coupled to at least one inflated section. The inflated toy possesses the appearance of a caterpillar, e.g., a caterpillar in motion.

Further embodiments of the present invention provide a method for spraying or delivering water from an inflated assembly which has a generally open “S” shape and supports a perforated hollow chamber or conduit. A hose member is coupled to the perforated hollow chamber. As water is being introduced from the hose member into the perforated hollow chamber, water commences to sprinkle or be discharged through perforations in the hollow chamber. The sprinkling or discharging of water from the generally open “S” shaped inflated assembly is in a generally “S” manner or format.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a perspective view of an embodiment of an inflated toy assembly discharging or delivering water through perforations in a hollow chamber which is supported by a plurality of inflated sections.

FIG. 2 is a top plan view of the embodiment of the inflated toy assembly of FIG. 1 and having an end with indicia which generally represents the face of a caterpillar.

FIG. 3 is a side elevational view of the embodiment of the inflated toy assembly of FIG. 1.

FIG. 4 is a bottom plan view of the embodiment of the inflated toy assembly of FIG. 1.

FIG. 5 is a side elevational view of the embodiment of the inflated toy assembly of FIG. 1 illustrating a hose member coupled to the perforated hollow chamber or conduit for delivering water into the perforated hollow chamber.

FIG. 6 is a vertical sectional view of the embodiment of the inflated toy assembly taken in direction of the arrows and along the plane of line 6-6 in FIG. 3.

FIG. 7 is a partial vertical sectional view illustrating one of the downwardly expanding indentations in one of the upper sections of the upper expanded assembly having a bottom surface that generally registers with the outside surface of one of the lower sections of the lower expanded assembly.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

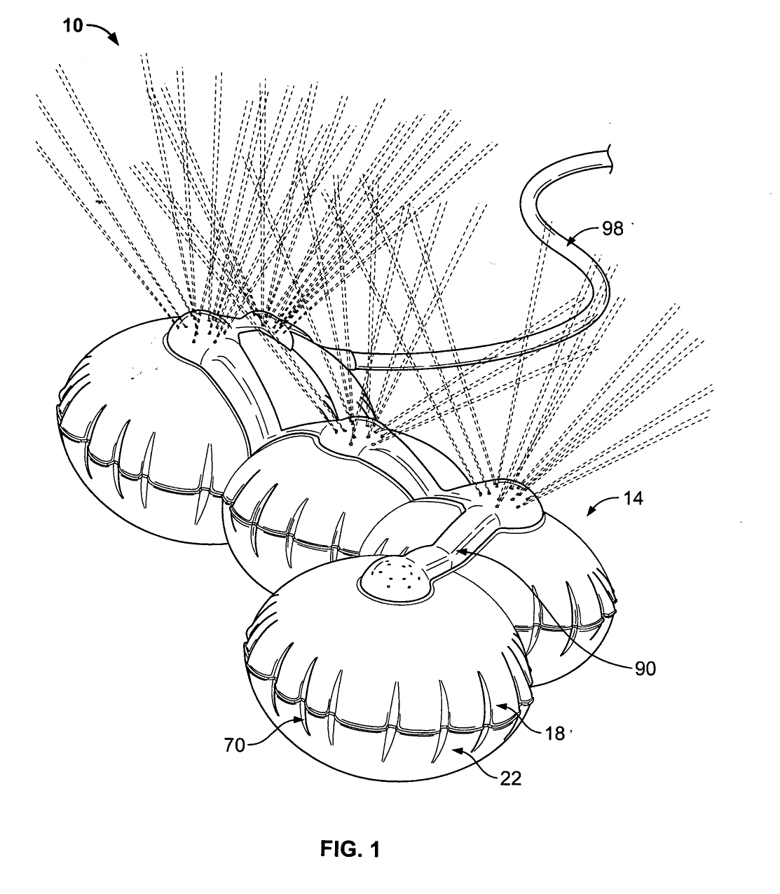

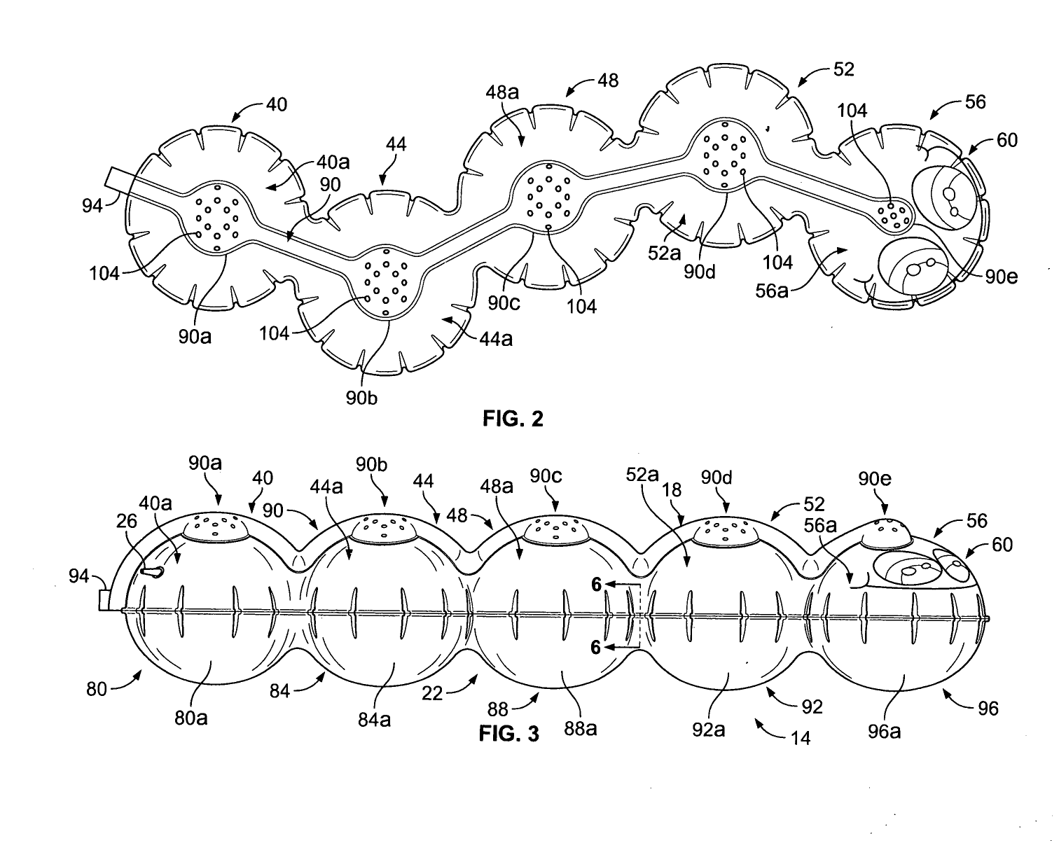

Referring in detail now to the drawings, wherein similar parts of the invention are identified by like reference numerals, there is seen in FIG. 1 a perspective view of the a toy assembly, generally illustrated as 10, having an inflated body 14. The toy assembly 10 is capable of being deflated into a collapsed position (not shown), or inflated into an expanded position which is illustrated in FIG. 1. The body 14 of the toy assembly 10 is inflated from a collapsed state into an expanded shape by introducing air through an inlet valve 26, which is similar to a valve for introducing air into an automobile tire. In an expanded position, the body 14 comprises a generally open “S” shape (see FIG. 2) and an upper inflated assembly 18 and a lower inflated assembly 22 which is coupled to (e.g., integrally bound to) the upper inflated assembly 18. When the upper inflated assembly 18 is being expanded by air being introduced through inlet valve 26, lower inflated assembly 22 commences to also expand. The toy assembly 10 may be manufactured from any suitable material. Preferably, the toy assembly 10 is made from plastic (e.g., vinyl or the like).

The upper inflated assembly 18 comprises a plurality of upper expanded sections (i.e., inverted bowl-shaped upper expanded sections), each having upper arcuate surface, bowl shaped surface, or sinusoidal-shaped surface from a side elevational view. The upper expanded sections are respectively identified as 40, 44, 48, 52 and 56, all of which are interconnected such as to generally expand together when air is introduced through value 26. The associated arcuate surfaces of upper expanded sections 40, 44, 48, 52 and 56 are respectively identified as 40a, 44a, 48a, 52a and 56a. The surface 56a supports indicia 60, which preferably represents a pair of eyes and a mouth, more preferably generally illustrating the eyes and mouth of a caterpillar.

In an embodiment of the invention the arcuate surfaces 40a, 44a, 48a, 52a and 56a each preferably includes a plurality of downwardly expanding, or upper tapering, recesses or indentations, all of which are identified as 70 on the surfaces 40a, 44a, 48a, 52a and 56a. The indentations 70 have a bottom 70a which generally registers with the outside surface of one of the lower expanded sections (respectively identified hereafter as 80, 84, 88, 92 and 96). This is illustrated in FIG. 7, by way of example only, where there is seen upper surface 40a of upper expanded section 40 having an indentation 70 including a bottom 70a which registers with the lower surface 80a of lower expanded section 80.

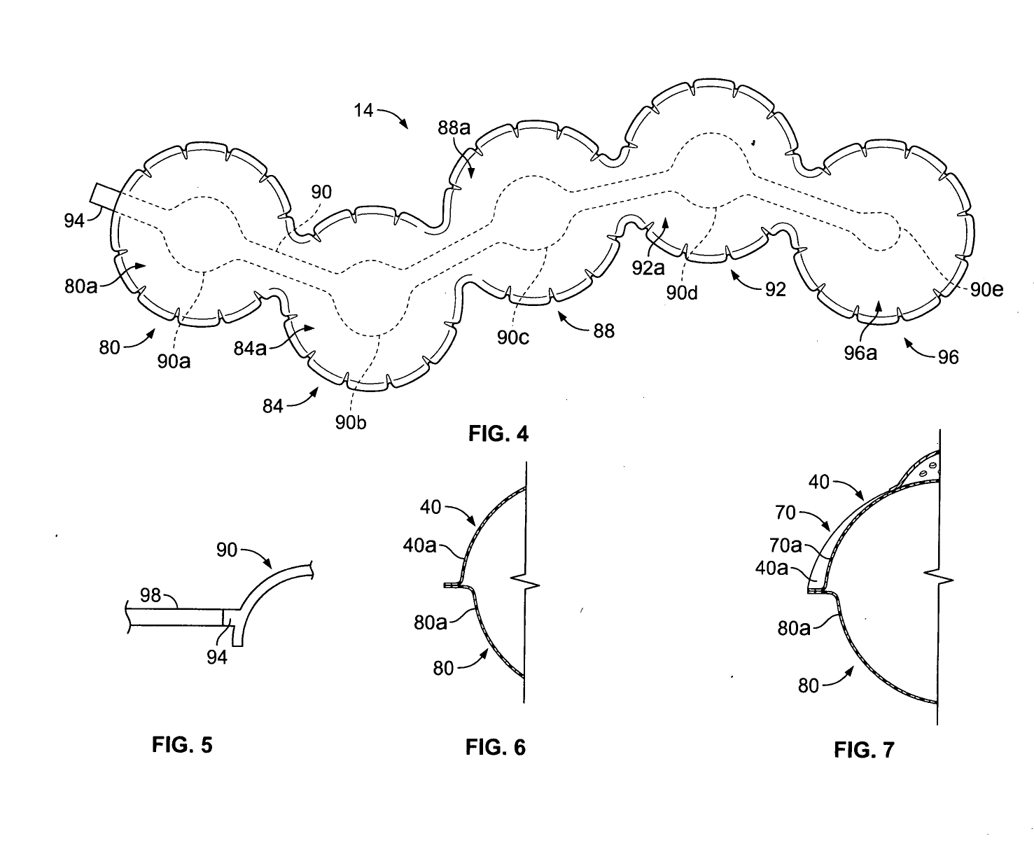

The lower inflated assembly 22 comprises a plurality of lower expanded sections (i.e., bowl-shaped lower expanded sections), each having lower arcuate surface, bowl shaped or sinusoidal-shaped surface from a side elevational view. The lower expanded sections are respectively identified as 80, 84, 88, 92 and 96, all of which are interconnected such as to generally expand together when air is introduced through value 26. As best illustrated in FIG. 4, the associated arcuate surfaces of lower expanded sections 80, 84, 88, 92 and 96 are respectively identified as 80a, 84a, 88a, 92a and 96a. The upper arcuate surfaces 40a, 44a, 48a, 52a and 56a of respective upper expanded sections 40, 44, 48, 52 and 56 overlap and/or extend beyond the lower arcuate surfaces 80a, 84a, 88a, 92a and 96a of lower expanded sections 80, 84, 88, 92 and 96. This is illustrated in FIG. 6, by way of example only, where there is seen upper surface 40a of upper expanded section 40 overlapping and/or extending beyond lower surface 80a of lower expanded section 80. The lower surface 80a terminates in an edge that is disposed inwardly from an edge of the upper surface 40a such that the edge of the upper surface 40a is generally aligned with the edge of the lower surface 80a.

The toy assembly 10 further comprises a generally hollow strip or chamber, generally illustrated as 90. The hollow chamber 90 is coupled to the upper arcuate shaped surfaces 40a, 44a, 48a, 52a and 56a of the respective upper expanded sections 40, 44, 48, 52 and 56 such as to conform to the shape of the surfaces 40a, 44a, 48a, 52a and 56a (as best shown in FIG. 3). As best shown in FIG. 5, the hollow chamber 90 has a water inlet conduit 94 which couples to a hose 98 for introducing water into the hollow chamber 90. The hollow chamber 90 further has a plurality of generally circular (e.g., partially circular) chamber sections, identified as 90a, 90b, 90c, 90d and 90e.

Each of the chamber sections (i.e., 90a, 90b, 90c, 90d and 90e) has a plurality of perforations or apertures, all identified as 104 in each of chamber sections. Chamber sections 90a, 90b, 90c, 90d and 90e are respectively disposed on the apexes of surfaces 40a, 44a, 48a, 52a and 56a, preferably such as to be generally concentric with the upper expanded sections 40, 44, 48, 52 and 56, respectively. Chamber section 90e terminates at the apex of upper expanded section 56 and has fewer perforations 104 than the perforations 104 respectively associated with chamber sections 90a, 90b, 90c, and 90d.

In operation of various embodiments of the invention, the inflated body 14 of the inflated toy 10 has (from a top plan view perspective) a generally open “S” shape and supports the hollow chamber 90. The hose member 98 is coupled to the inlet valve 26. Water is passed through hose 98, through inlet valve 26 and into the hollow chamber 90. As water is being introduced from the hose 98 into the hollow chamber 90, water commences to sprinkle or be discharged through perforations 104 in the hollow chamber 90. The sprinkling or discharging of water from the generally open “S” shaped inflated assembly 10 (i.e., from an “S” shaped base) is in a generally “S” manner or format.

One of the features of embodiments of the present invention is the hollow chamber 90 tapering down from chamber section 90d into a smaller chamber section 90e located in close proximity to and between indicia representing eyes. Another feature of embodiments of the present invention is the sprinkling, discharging or the delivering of water from the perforations in the chamber sections 90a, 90b, 90c, 90d, and 90e which are respectively located at the apexes of surfaces 40a, 44a, 48a, 52a and 56a. Thus, water emanates from the apexes. A further feature of embodiments of the present invention is that the hollow chamber 90 is capable of delivering water at a pressure up to about 250 psi, more particularly from 100 psi to 250 psi, most particularly from 200 psi to 250 psi. Another further feature of the present invention is that as water passes through the hollow strip or chamber 90, the pressure of the water against the internal surfaces of the hollow chamber 90 causes the surfaces 40a, 44a, 48a, 52a and 56a to be selectively depressed or deflected (in a cushion like manner) to facilitate the passage of water through the hollow chamber 90 for discharge through the perforations 104. Embodiments of the invention also provide water traveling in a generally undulating manner.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A recreational toy comprising: an inflated body having a plurality of inflated upper sections and a plurality of lower inflated lower sections coupled to the inflated upper sections; and a perforated hollow chamber coupled to the inflated upper sections.

2. The toy of claim 1 wherein each of said inflated upper sections has an apex and perforations of said perforated hollow chamber are disposed on the apexes of said inflated upper sections.

3. The toy of claim 2 wherein each of said inflated upper sections include an arcuate surface having a structure defining a plurality of recesses.

4. The toy of claim 3 wherein each of said inflated lower sections include an arcuate surface.

5. The toy of claim 4 wherein each of said recesses comprise a bottom which generally registers with the arcuate surface of said inflated lower sections.

6. The toy of claim 5 wherein said arcuate surfaces of said inflated upper sections terminate in edges that are generally aligned with edges of the inflated lower sections.

7. The toy of claim 6 wherein said edges of said inflated upper sections extend outwardly from said edges of said inflated lower sections.

8. The toy of claim 7 wherein the perforated hollow chamber terminates at the apex of one of the inflated upper sections.

9. The toy of claim 8 wherein said inflated upper section where said perforated hollow chamber terminates includes indicia.

10. The toy of claim 9 wherein said perforated hollow section tapers toward the inflated upper section where said perforated hollow chamber terminates.

11. A method for discharging water comprising: introducing water into a perforated hollow chamber supported by outside surfaces of a plurality of inflated upper sections which are coupled to a plurality of inflated lower sections, and discharging water through perforates in the perforated hollow chamber at apexes of the inflated upper sections.

12. The method of claim 11 additionally comprising selectively depressing the outside surfaces of said inflated upper sections as said water travels through the perforated hollow chamber.

13. The method of claim 12 wherein said discharging of water is in a generally “S” format.

14. The method of claim 13 wherein said water travels in a generally undulating manner.
